(19) United States
(12) Patent Application Publication
(10) Pub. No.: US 2022/0048241 A1
(43) Pub. Date: Feb. 17, 2022

(54) CONSOLIDATED COMPOSITES FROM METAL MATRIX COMPOSITE TAPE

(71) Applicant: Touchstone Research Laboratory, Ltd., Triadelphia, WV (US)

(72) Inventors: Brian L. Gordon, Wheeling, WV (US); Neven W. Cook, Wheeling, WV (US)

(21) Appl. No.: 16/947,750

(22) Filed: Aug. 14, 2020

(51) Int. Cl. B29C 53/80; B29C 70/38

(52) U.S. Cl. CPC B29C 53/8016; B29C 53/66; B29C 53/8066; B29C 70/386

(57) ABSTRACT

A winding method and apparatus for producing a consolidated metal matrix composite is described. The methods are directed to winding softened metal matrix composite tape and layering the resulting softened metal matrix composite tape onto a rotating mandrel in a prescribed pattern on the surface of the mandrel to form a consolidated metal matrix composite. Upon cooling, the matrix metal solidifies and the resulting consolidated metal matrix composite may be removed from the mandrel. The consolidated metal matrix composites may be produced in a variety of shapes, such as cylinder, a tapered cylinder, a sphere, an ovoid, a cube, a rectangular solid, a polygonal solid, and panels.

### FIELD OF THE INVENTION

The invention relates to consolidated metal matrix composites (“MMC”) and methods and apparatuses for making these composites. More particularly, the invention relates to direct filament winding of softened metal matrix composite tapes for the production of consolidated metal matrix composite components.

### BACKGROUND OF THE INVENTION

The next generation of high technology materials for use in aerospace and aircraft applications will need to possess high temperature capability combined with high stiffness and strength. Components fabricated from laminated metal matrix composites, as opposed to monolithic materials, provide the potential for meeting these requirements and thereby significantly advancing the designer's ability to meet the required elevated temperature and structural strength and stiffness specifications while minimizing weight.

These types of laminated metal matrix composites generally have relatively long continuous lengths of a reinforcing fibrous material, such as aluminum oxide, in a matrix of a metal such as aluminum. Continuous fiber metal matrix composite structures may be generally formed by casting the molten matrix metal into a mold containing a preform of fibers. Pressure may be used to force the matrix metal to surround the fibers. The casting molds used in this type of process are expensive, with the cost dramatically increasing as the size of the mold increases.

Fiber reinforced metal matrix composite tubes or cylinders have been prepared by winding preformed fiber reinforced aluminum tapes on a mandrel. The wound metal matrix composite tapes are consolidated with adjacent tape layers by providing a brazed layer on one side of the tape and brazing the adjacent tape layers to one another as the tape is wound on the mandrel, thereby joining and immediately consolidating the laid-down tapes to form a cylinder. The resulting composite tubes generally provide layers of the matrix metal containing the reinforcing fibers and layers of the brazing material.

### SUMMARY OF THE INVENTION

The invention is generally directed to consolidated metal matrix composites and the apparatuses and methods for forming consolidated metal matrix composites by winding a softened metal matrix composite tape on a rotating mandrel. The metal in the softened metal matrix composite tape may be partially or fully molten. The metal of overlapping softened metal matrix composite tape on the mandrel intermixes and consolidates to form a substantially void-free bond between adjacent and overlapping metal matrix composite tape. Upon cooling, the matrix metal solidifies thereby producing a consolidated metal matrix composite cylinder. The resulting consolidated metal matrix composite cylinder has a body portion where the matrix metal is substantially continuous with no substantial voids.

Certain embodiments of the invention include a metal matrix composite tape winding apparatus comprising a furnace adapted to form and contain a metal bath, a rotating mandrel positionable within the furnace such that the rotating mandrel would be submerged upon the formation of the metal bath, and a tape source and a rotating payout unit connected to a carriage, wherein the rotating payout unit is positioned within the furnace such that the rotating payout unit would be submerged upon the formation of the metal bath, wherein the carriage is moveable laterally and parallel to an axis of rotation of the rotating mandrel, and wherein the carriage maintains a constant orientation of the tape source and rotating payout unit while the carriage is moving.

In certain embodiments, the invention may include a method for forming a consolidated metal matrix composite, comprising the steps of supplying metal matrix composite tape from a tape source to a rotating payout unit submerged in a metal bath, wherein the tape source and rotating payout unit are connected to a carriage, applying metal matrix composite tape from the rotating payout unit onto a rotating mandrel submerged in the metal bath, and moving the carriage laterally and substantially parallel to the axis of rotation of the rotating mandrel a predetermined distance and speed to provide overlapping layers of metal matrix composite tape around the rotating mandrel, whereby the tape source and rotating payout unit maintain a constant orientation as the carriage moves, and whereby the overlapping layers of metal matrix composite tape intermix and consolidate with adjacent layers of metal matrix composite tape to provide a consolidated metal matrix composite.

The method may also include the step of positioning the softened metal matrix composite tape on the rotating mandrel where the softened metal matrix composite tape has an angle of approach to the rotating mandrel ranging from about 0 degrees to about 180 degrees. The angle of approach may be about 90 degrees. The method may also include the step of varying the angle of approach to the rotating mandrel during the layering step. The method may further include the step of laterally moving said rotating mandrel.

### BRIEF DESCRIPTION OF THE FIGURES

FIG. 1 is a diagrammatic view of a filament winding apparatus in accordance with an embodiment of the invention.

FIG. 2 is a perspective view of a rotating payout roller in accordance with an embodiment of the invention.

FIG. 3 is a front view of a rotating payout roller in accordance with an embodiment of the invention.

FIG. 4 is a rear view of a rotating payout roller in accordance with an embodiment of the invention.

FIG. 5 is a rear view of a rotating payout roller in which the roller has been rotated at an angle in accordance with an embodiment of the invention.

### DETAILED DESCRIPTION OF EMBODIMENTS OF THE INVENTION

Some preferred embodiments of the present invention are described in this section in detail sufficient for one skilled in the art to practice the present invention without undue experimentation. It is to be understood, however, that the fact that a limited number of preferred embodiments are described in this section does not in any way limit the scope of the present invention as set forth in the claims.

It is to be understood that whenever a range of values is described herein, i.e. whether in this section or any other part of this patent document, that the range includes the end points and every point therebetween as if each and every such point had been expressly described. Unless otherwise stated, the words “about” and “substantially” as used herein are to be construed as meaning the normal measuring and/or fabrication limitations related to the value or condition which the word “about” or “substantially” modifies. Unless expressly stated otherwise, the term “embodiment” is used herein to mean an embodiment of the present invention.

The invention is generally directed to an apparatus and methods for winding softened metal matrix composite tapes on a rotating mandrel where the metal of overlapping softened metal matrix composite tapes intermix and consolidate to form consolidated metal matrix composite. The softened metal is the matrix metal of the matrix composite tape that is in a molten state or at a temperature such that the matrix metal can be deformed and consolidated with adjacent metal matrix composite tapes with minimal force.

The resulting consolidated metal matrix composites may have a variety of cross-sectional geometric shapes. The shapes of the consolidated metal matrix composites may include, among other shapes, tubes and cylinders of various sizes and shapes. These tubes and cylinders may be used to form articles such as pipes, ducts, feed lines, pressure vessels, storage tanks, fuel tanks, golf club shanks and shafts, and other articles too numerous to mention that utilize these shapes. The methods and apparatuses of the invention significantly reduce the cost for the production of consolidated metal matrix composites by eliminating the need for molds and associated tooling typically used in such processes.

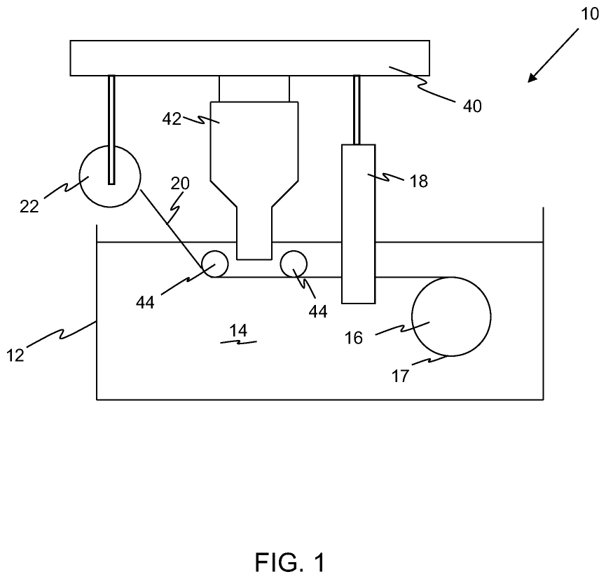

With reference now to FIG. 1, an illustration of a filament winding apparatus for forming a consolidated metal matrix composite in accordance with an embodiment of the invention is shown and generally depicted by the reference numeral 10. The filament winding apparatus 10 generally includes a furnace 12 containing a metal bath 14, a rotating mandrel 16, and a rotating payout roller 18 adapted to direct the placement of softened metal matrix composite tape 20 onto the rotating mandrel 16. As illustrated in FIG. 1, the metal matrix composite tape 20 may be feed from a tape source such as a spool 22 into the metal bath 14, through the submerged rotating payout roller 18 and placed onto the submerged rotating mandrel 16.

Metal matrix composite tape 20 comprises fibers embedded in a metal matrix. Exemplary fibers, depending on the selected matrix metal, include, but are not limited to, carbon fibers, boron fibers, silicon carbide fibers, aluminum oxide fibers, glass fibers, quartz fibers, basalt fibers, ceramic fibers, metal fibers, and combinations thereof. Possible matrix metals depending on the selected fibers include, but are not limited to, aluminum, magnesium, silver, gold, platinum, copper, palladium, zinc, including alloys and combinations thereof. In certain preferred embodiments the metal matrix is aluminum or an aluminum alloy matrix and the fibers may include one or more fibers including, alumina (Al₂O₃), some other appropriate ceramic, carbon, boron, glass fibers, or combinations thereof. In certain preferred embodiments, the metal matrix composite tape includes high-strength/stiffness aluminum oxide fibers in an Aluminum 1100 matrix. The fibers embedded in the matrix are oriented substantially parallel to the length of the metal matrix composite tape. Further the fibers are generally continuous along the length of the metal matrix composite tape, such that the length of the embedded fibers is substantially the same as the length of the metal matrix composite tape. In some embodiments shorter fibers may be used, however, the length of the fibers should be longer than the diameter of the fiber. Suitable metal matrix composite tapes include METPREG® fiber reinforced aluminum tape commercially available from Touchstone Research Laboratory.

The dimensions of the metal matrix composite tape 20 are not particularly limited and may be selected depending on the application. The metal matrix composite tape may be cut to specific lengths or may be available as a coil in longer lengths and then used in a continuous fashion to feed metal matrix composite tape to the filament winding apparatus. The width of the metal matrix composite tape is not particularly limited and may be selected based on the desired application. Typical ranges for the width of metal matrix composite tape may include from about 0.5 inch to 2 inches or larger. Similarly, the thickness of the metal matrix composite tape is not particularly limited. Typical thickness of metal matrix composite tape may range from about 0.010 inch to about 0.030 inch thick, and preferably about 0.015 inch thick. The cross-sectional shape of the metal matrix composite tape is not particularly limited but preferably includes relatively flat sides than may be abutted against flat sides of adjacent pieces of metal matrix composite tape. Suitable cross-sectional shapes may include regular or irregular polygons, including but not limited to, a regular triangle, an acute triangle, a right triangle, an obtuse triangle, a parallelogram, a square, a rectangle, a trapezium, a kite, a rhombus, a pentagon, a hexagon, a heptagon, an octagon, a nonagon, a decagon, or other quadrilateral. In certain embodiments, the metal matrix composite tape has a rectangular cross section.

As illustrated in FIG. 1, the filament winding apparatus includes a furnace 12 that contains the metal bath 14. The metal bath 14 includes the metal that is preferably the same metal as the matrix metal of the metal matrix composite tape. The furnace 12 should be able to sustain a temperature that will liquefy at least a portion of the metal used to form the metal bath 14. The size of the furnace 12 is sized to at least receive the rotating mandrel 16 and the rotating payout roller 18 such that the rotating mandrel 16 and the rotating payout roller 18 may be submerged in the metal bath 14. The size of the furnace 12 may vary based on the size of the rotating mandrel 16 and the rotating payout roller 18. In certain embodiments, the size of the furnace 12 may be large enough such that the rotating payout roller 18 can move laterally, parallel to the axis of rotation of the rotating mandrel 16 and along the length of the rotating mandrel 16 while submerged in the metal bath 14.

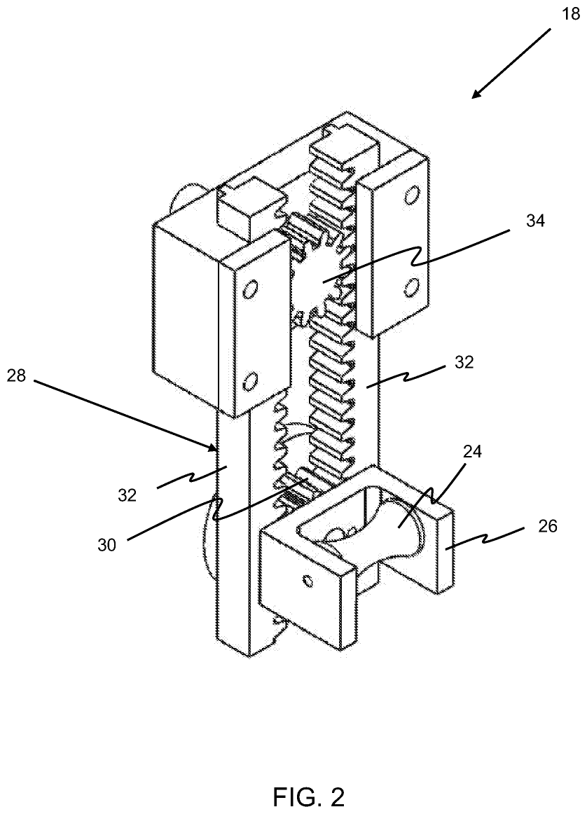

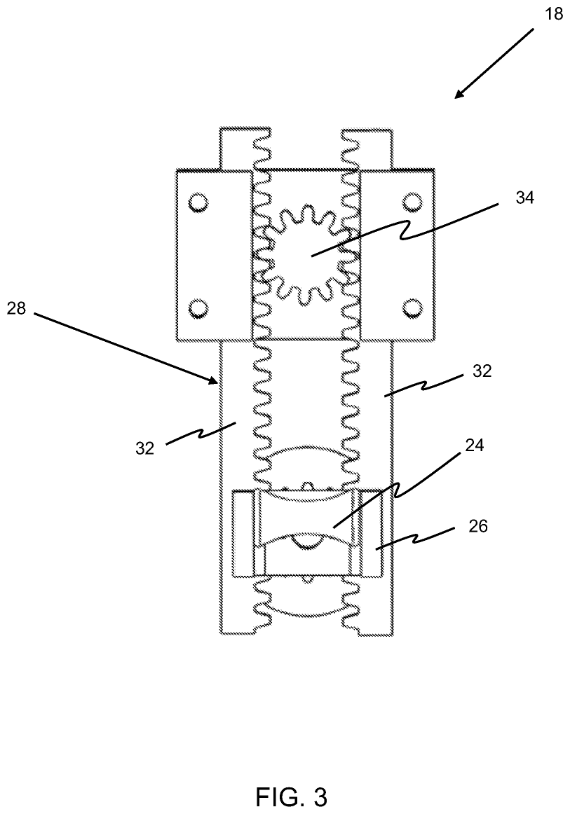

The rotating payout unit 18 is adapted to direct the position of the metal matrix composite tape 20 onto the rotating mandrel 16. With reference now to FIGS. 2-5 there is illustrated a rotating payout unit 18 in accordance with an embodiment of the invention. The rotating payout unit 18 includes a roller 24 that is mounted in a roller mount 26 such that the roller 24 is free to rotate around a rotational axis within the roller mount 26. The shape of the roller 24 is not particularly limited. As the metal matrix composite tape 20 is fed onto the rotating mandrel 16, the metal matrix composite tape 20 engages the surface of the roller 24. Accordingly, the shape of the roller 24 is preferably smooth and allows for efficient movement of the tape over the surface of the roller 24 and on to the rotating mandrel 16. In certain embodiments, the shape of roller 24 may be cylindrical with a flat, concave or convex cylindrical surface.

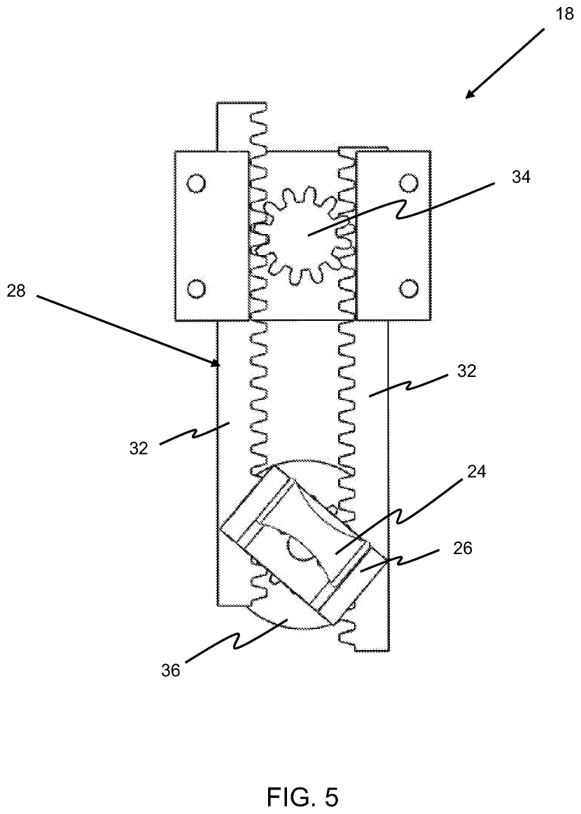

The roller mount 26 it is attached to a rotating mechanism 28 that rotates the roller mount 26 a predetermined or selected number of degrees. The rotating mechanism 28 it is not particularly limited and may include any configuration that can rotate the roller mount 26. The embodiment illustrated in FIGS. 2-5, The rotating mechanism 28 uses a gear 30 connected to the roller mount 26 and a pair of rails 32 adapted to engage the sprockets of gear 30. The rotating mechanism 28 may include and a drive gear 34 positioned between and engaged with the pair of rails 32 where the sprockets of the drive gear 34 engage sprockets of the rails 32. When the drive gear 34 is rotated, one of the rails 32 moves upward while the other rail moves downward thereby turning the gear 30 and rotating the roller mount 26 as illustrated in FIG. 5. A motor may be used to turn the drive gear 34 and may be programmed to provide rotation of the roller mount 26 in accordance with the desired placement of metal matrix composite tape on the rotating mandrel 16. In some embodiments, the roller mount 26 may be rotated 180° in both directions.

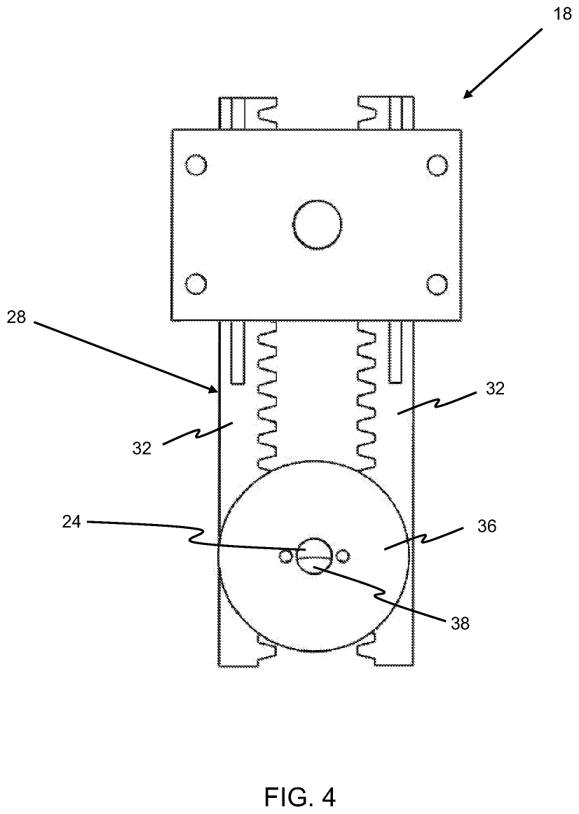

With reference to FIG. 4, the rotating payout unit 18 may also include an entrance guide 36 adapted to receive metal matrix composite tape 20 and direct the metal matrix composite tape 20 to the roller 24. The entrance guide 36 defines an entry hole 38 in line with the roller 24 and sized to allow metal matrix composite tape 20 to pass through to the roller unobstructed. The rotating payout unit 18 is preferably constructed of a material that maintains its shape and structural integrity when exposed to the metal bath and matrix composite tapes. For many applications, the components of the rotating payout unit 18 may be fabricated from graphite, metal, or suitable ceramic or refractory materials.

In some embodiments, the rotating payout unit 18 and the spool 22 are connected to a carriage 40. This allows for the metal matrix composite tape 20 to be delivered to the rotating payout unit 18 at a constant orientation. In this embodiment, the carriage 40 is allowed to move laterally and parallel to the rotational axis of the rotating mandrel 16. In this way, the rotating payout unit 18 is moved laterally and parallel to the rotational axis of the rotating mandrel 16 by virtue of the movement of the carriage 40 while maintaining a constant approach or orientation of the metal matrix composite tape 20 coming from the spool 22. The carriage 40 allows for the vertical positioning of the rotating payout unit 18 within the metal bath 14.

With reference now to FIG. 1 a rotating mandrel 16 may be provided near rotating payout unit 18 to receive the softened metal matrix composite tape 20 from the rotating payout unit 18. The rotating mandrel 16 may be positioned above, partially submerged or completely submerged in the metal bath 14. For positioning the rotating mandrel 16, the rotating mandrel may be connected to a rotating mandrel positioning device. In certain embodiments, the rotating mandrel 16 is positioned such that the axis of rotation for the rotating mandrel 16 is approximately normal to the principle axis of the softened matrix composite tape 20 exiting the rotating payout unit 18. In some embodiments, the rotating mandrel 16 may be moved in a direction relatively parallel to the axis of rotation by using any well known mechanism such as a linear motion motor to provide for additional control of the layering of the metal matrix composite tape on the mandrel.

The mandrel 16 may have variety of cross-sectional shapes, including, but not limited to circular, oval, elliptical, square, triangular, rectangular, regular polygonal, irregular polygonal, planar and other similar cross-sections. Optionally, one end of the mandrel may have a shaped surface for forming a closed end of the consolidated metal matrix composite during the winding process. The mandrel 16 may be fabricated from any suitable material that is not significantly wet by the matrix metal and which is substantially chemically inert to the matrix metal and fiber bundle. The mandrel is preferably capable of tolerating the operating temperatures of the metal bath, with a coefficient of thermal expansion greater than or equal to that of the resulting consolidated metal matrix composite. The mandrel should have sufficient strength to support the layered or positioned softened metal matrix composite tapes and the resultant consolidated metal matrix composite. For many applications, the mandrel may be made of graphite, metal, or suitable ceramic or refractory materials. The mandrel is preferably constructed to allow for removal of the consolidated metal matrix composite, for example, by slotting, disassembling, collapsing, machining away, or dissolving the mandrel.

Optionally, the filament winding apparatus 10 may also include an infiltration unit 42 to facilitate additional infiltration of metal into the metal matrix composite tape. Infiltration generally refers to surrounding individual fibers in the metal matrix composite tape with the matrix metal such that there is minimal or substantially no void space in the matrix composite tape.

The infiltration unit 42 is adapted to facilitate the wetting and infiltration of the metal matrix composite tape 20. The infiltration unit 42 may include a sonic processor, such as an ultrasonic processor known to those skilled in the art. The sonic processor facilitates the wetting and infiltration of the metal in the metal bath 14 into the metal matrix composite tape 20. The sonic processor may include a waveguide for directing the sonic energy. The sonic processor may be one of a variety of commercially available units. The waveguide should be able to withstand the conditions of the metal bath 14. The infiltration unit 42 may be connected to the carriage and is independently positionable to allow for the raising and lowering the infiltration unit such the distance between the waveguide and the fiber bundles may be varied.

To assist in the handling and positioning of the metal matrix composite tape 20 when using an infiltration unit 42, one or more rollers 44 may be provided to orient and direct the metal matrix composite tape into the metal bath and pass the metal matrix composite tape near or across the infiltration unit 42.

With reference now to FIG. 1, the metal matrix composite tape 20 may be continuously fed into the metal bath 14 and to an optional infiltration unit 42 immersed into the metal bath 14. Where the fibers enter or exit the metal bath, it may be advantageous to provide an inert gas such as nitrogen or argon around the point of entry to minimize the formation of a metal oxide film on the surface of the metal bath. As the metal matrix composite tape enters or exits the bath this film may get picked up by the metal matrix composite tape producing defects in the matrix composite tape or consolidated metal matrix composite.

The metal matrix composite tape passes from the optional infiltration unit 42, and directed to the rotating payout roller 18 whereby the metal matrix composite tape is positioned on the rotating mandrel 16 which may be submerged or partially submerged in the metal bath 14. As the rotating mandrel 16 rotates to take up metal matrix composite tape 20, the carriage 40 moves laterally back and forth along the rotational axis of the rotating mandrel 16 at a predetermined or programmed speed until the desired amount of metal matrix composite tape 20 is applied to the rotating mandrel.

As the mandrel 16 rotates, the softened metal matrix composite tape 20 may be layered onto the mandrel in prescribed patterns with a sufficient number of layers to cover the surface of the mandrel to form a consolidated metal matrix composite 17. The pattern in which the matrix composite tapes is layered may vary widely and may be controlled through movement of the carriage and the speed of the rotating mandrel. The distance and speed in which the carriage is moved along the axis of rotation relative to the rotational speed of the mandrel during the layering of the matrix composite tapes can determine the orientation of the fibers in the resulting consolidated metal matrix composite. The orientation of the layering of the matrix composite tapes includes, but is not limited to circular or hoops about the axis of rotation or helical patterns that result in a woven appearance.

Once the softened metal matrix composite tape 20 is wound on the rotating mandrel 16, the matrix metal may be allowed to harden, such as by cooling, on the mandrel thereby producing a consolidated metal matrix composite. The consolidated metal matrix composite may then be removed from the mandrel. Allowing the matrix metal to harden prior to removing the consolidated metal matrix composite ensures that the desired cross-sectional shape is maintained.

Preferably, the formation of metal oxides on the surface of the softened matrix metal is minimized between and during infiltration and consolidation. Such oxides may inhibit adequate bonding between successive layers of the matrix metal of the matrix composite tape on the mandrel. Oxide development may be prevented, or its formation inhibited, by performing the above operations in an environment that is essentially inert to the formation of oxides. Such an environment may be provided by performing the operations described above at least partially immersed in a bath of the molten matrix metal. Use of a molten matrix metal bath may lead to the development of dross on the bath surface. Care should be exercised that dross does not become entrapped or incorporated into or on the matrix composite tape. Alternatively, the operations described above may be completely or partially performed in a heated environment such as provided by an oven, a furnace, or other heating apparatus having an atmosphere that is essentially inert, or non-reactive, to the formation of oxides.

Without intending to limit the scope of the invention, the consolidated metal matrix composites may be formed in a variety of cross-sectional shapes such as circular, oval, elliptical, square, triangular, rectangular, regular polygonal, irregular polygonal, planar and other similar cross-sectional shapes depending on the shape of the rotating mandrel. Further, the consolidated metal matrix composites may have shapes including, but not limited to, a cylinder, a tapered cylinder, a sphere, an ovoid, a cube, a rectangular solid, a polygonal solid, a panel, and a disk

Generally, the matrix metal in the consolidated metal matrix composite is consolidated and integrally formed throughout the shape of the consolidated metal matrix composite such that there are no voids or only minimal voids or gaps between adjacent matrix composite tapes. The properties of the resulting metal matrix composites will vary widely depending on such factors as the matrix metal, the fibers, the number of layers used to form the composite, and the orientation of the fibers within the composite. Generally, the consolidated metal matrix composites can hold gas and liquid pressures when sealed at both ends. The pressure that the composite can withstand will depend upon the above mentioned factors.

While several embodiments of the present invention have been shown and described, it will be obvious to those skilled in the art that many changes and modifications may be made thereunto without departing from the spirit and scope of the invention as described in the claims. All United States patents and patent applications, all foreign patents and patent applications, and all other documents identified herein are incorporated herein by reference as if set forth in full herein to the full extent permitted under the law.

What is claimed is:

1. A method for forming a consolidated metal matrix composite, comprising the steps of:
supplying metal matrix composite tape from a tape source to a rotating payout unit submerged in a metal bath, wherein the tape source and rotating payout unit are connected to a carriage;
applying metal matrix composite tape from the rotating payout unit onto a rotating mandrel submerged in the metal bath; and
moving the carriage laterally and substantially parallel to the axis of rotation of the rotating mandrel a predetermined distance and speed to provide overlapping layers of metal matrix composite tape around the rotating mandrel, whereby the tape source and rotating payout unit maintain a constant orientation as the carriage moves, and whereby the overlapping layers of metal matrix composite tape intermix and consolidate with adjacent layers of metal matrix composite tape to provide a consolidated metal matrix composite.

2. The method of claim 1, further comprising the step of positioning the softened metal matrix composite tape on said rotating mandrel wherein the softened metal matrix composite tape has an angle of approach to an axis of rotation of the rotating mandrel ranging from about 0 degrees to about 180 degrees.

3. The method of claim 1, further comprising the step of laterally moving said rotating mandrel.

4. The method of claim 1, wherein said overlapping step further comprises the step of layering said softened metal matrix composite tape over an end of the rotating mandrel.

5. A metal matrix composite tape winding apparatus comprising:
a furnace adapted to form and contain a metal bath;
a rotating mandrel positionable within the furnace such that the rotating mandrel would be submerged upon the formation of the metal bath; and
a tape source and a rotating payout unit connected to a carriage, wherein the rotating payout unit is positioned within the furnace such that the rotating payout unit would be submerged upon the formation of the metal bath, wherein the carriage is moveable laterally and parallel to an axis of rotation of the rotating mandrel, and wherein the carriage maintains a constant orientation of the tape source and rotating payout unit while the carriage is moving.

6. The metal matrix composite tape winding apparatus of claim 1, wherein the tape source is a spool containing metal matrix composite tape.

7. The metal matrix composite tape winding apparatus of claim 1, wherein the rotating payout unit comprises a roller that is rotatable 180° in both directions.
